(19) United States
(12) Patent Application Publication
(10) Pub. No.: US 2010/0328103 A1
(43) Pub. Date: Dec. 30, 2010

(54) Image enhanced parking enforcement system

(76) Inventors: Stuart O. Goldman, Scottsdale, AZ (US); James P. Runyon, Wheaton, IL (US)

Correspondence Address: Docket Administrator - Room 3D-201E;Alcatel-Lucent USA Inc., 600-700 Mountain Avenue, Murray Hill, NJ, 07974, US

(21) Appl. No.: 12/456,920

(22) Filed: Jun. 24, 2009

(51) Int. Cl. G08G 1/14; H04N 7/18

(52) U.S. Cl. 340/932.2; 368/90; 348/61

(57) ABSTRACT

An image-enhanced parking enforcement system utilizes cameras or other imaging modality to capture, record and/or report instances of parking infractions corresponding to a controlled parking space. In one embodiment, a metering device monitors allotted times for lawful utilization of the parking space and identifies instances of meter expiration; at least one detector monitors utilization status of the parking space; and the cameras or other imaging modality captures images corresponding to the parking space when the meter has expired and the space is occupied.

### FIELD OF THE INVENTION

This invention relates generally to metered parking enforcement devices and systems.

### BACKGROUND OF THE INVENTION

Parking meters are well known tools for managing parking space utilization and generating revenue for municipalities or other controlling authorities. Parking meters vary in design and sophistication, but typically include a post or other suitable mounting structure for positioning the parking meter adjacent to a controlled parking space, coin slots or other means for accepting payment, and a display for indicating time purchased or remaining. Generally, there is an expectation that when parking in a metered space, the drivers or other vehicle occupants will enter coins or other form of payment into the parking meter, in an amount commensurate with the relevant parking fee structure, in order to lawfully park the vehicle in the space for a designated time. The amount of time available for purchase is often limited so as to discourage long term parking. If the vehicle is parked in the space without paying the meter, or if the meter expires while the vehicle is parked in the space, the vehicle owner will be subject to parking tickets, fines or the like.

However, parking meter enforcement typically relies on designated parking enforcement personnel (e.g., meter maids or the like) observing vehicles parked at expired meters. Often, there are relatively few meter maids performing the enforcement, resulting in sporadic, sometimes lengthy time periods before which the meter maids will patrol a particular parking area. Consequently, people will often “steal time” by unlawfully parking without paying the meter or by parking for longer than their allotted time in hopes that their infraction will not be observed and enforced. A related problem is that the act of observing and enforcing parking infractions can be very unfair. For example, the meter maid may observe and enforce some infractions when the meter has only recently expired, but miss or belatedly observe other cases where hours have elapsed. Typically the meter maid has no information as to how long ago the meter expired, or how long the vehicle has been parked in the expired space.

### SUMMARY OF THE INVENTION

These problems are addressed and a technical advance is achieved in the art by an image-enhanced parking enforcement system, whereby parking meters equipped with cameras or other imaging modality are implemented to capture, record and/or report instances of parking infractions. Advantageously, the image-enhanced parking enforcement system can be utilized to reduce or eliminate occurrences of “stealing time” from parking meters and to more equitably enforce the parking laws relative to human patrol schemes.

In one embodiment, there is provided a parking enforcement platform comprising a metering device, at least one detector and an imaging device. The metering device monitors allotted times for lawful utilization of the parking space and identifies instances of meter expiration; at least one detector monitors utilization status of the parking space; and the imaging device captures one or more images corresponding to the parking space when the parking space is occupied and the meter has expired.

In one embodiment, there is provided a method comprising steps of monitoring status of a metering device corresponding to a controlled parking space, the metering device operable to monitor allotted times for lawful utilization of the parking space and identify instances of meter expiration; monitoring utilization status of the parking space; and capturing one or more images corresponding to the parking space responsive to occupation of the parking space and meter expiration.

### BRIEF DESCRIPTION OF THE DRAWINGS

The foregoing and other advantages of the invention will become apparent upon reading the following detailed description and upon reference to the drawings in which:

FIG. 1 is a block diagram of an image-enhanced parking enforcement system according to an exemplary embodiment of the invention;

FIG. 2 is a block diagram of a parking enforcement platform that may be utilized in the system of FIG. 1 according to an embodiment of the invention;

FIG. 3 is a flowchart showing one manner of operating the image-enhanced parking enforcement system of FIG. 1 according to an exemplary embodiment of the invention; and

FIG. 4 is a flowchart showing another manner of operating the image-enhanced parking enforcement system of FIG. 1 according to an exemplary embodiment of the invention.

### DESCRIPTION OF THE PREFERRED EMBODIMENT(S)

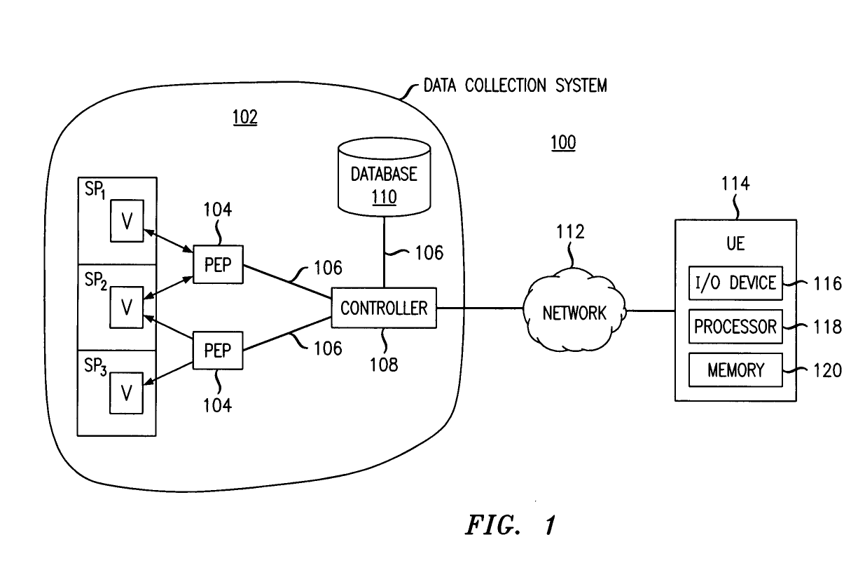

FIGS. 1-4 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an image-enhanced parking enforcement system 100 according to an exemplary embodiment of the invention. A data collection system 102 captures and stores parking enforcement information relative to various controlled parking spaces (three shown, SP₁, SP₂,.SP₃), including image data associated with vehicles (V) occupying the parking spaces. A plurality of parking enforcement platforms 104 (two shown PEP₁, PEP₂) form the heart of the data collection system 102.

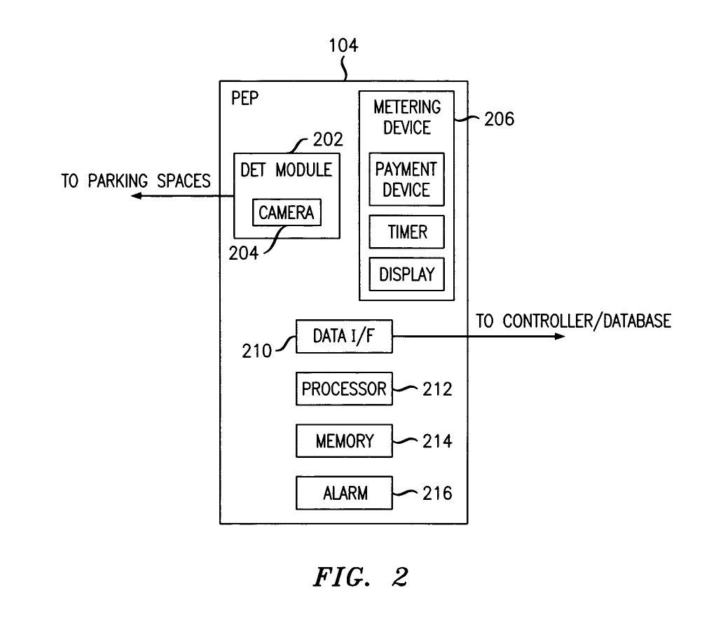

In one embodiment, the parking enforcement platforms 104 are located adjacent to the various parking spaces SP₁, SP₂,.SP₃, as shown (for example and without limitation, on a parking meter post or the like, or placed in the pavement or curb) and perform a metering function in similar fashion to conventional parking meters. For example, so called “metering functions” may include receiving payment, monitoring and displaying time allotted for lawful utilization of the parking space (i.e., time purchased or remaining (or expiration of time)) and displaying indicia of the time remaining or meter expiration. In one embodiment, as will be described in greater detail in relation to FIG. 2, the parking enforcement platforms further perform a detection function for detecting parking space utilization (e.g., the presence or absence of vehicles (V) or other blocking structures) in the parking spaces SP₁, SP₂,.SP₃; and an imaging function for capturing image data associated with vehicles (V) occupying the parking spaces SP₁, SP₂,.SP₃. As will be appreciated, the parking enforcement platforms are functional elements that may reside in one or more physical structures and may be utilized to monitor individual spaces or multiple spaces. The parking enforcement platforms may or may not be implemented in conventional fashion, on a parking meter post or the like, or placed in the pavement or curb. The number of parking enforcement platforms 104 need not correspond exactly to the number of parking spaces and need not be located immediately adjacent to the parking spaces.

In one embodiment, the data collection system 102 includes a controller 108 for controlling and coordinating operation of the parking enforcement platforms 104 and to receive and process parking enforcement information received from the parking enforcement platforms 104. The parking enforcement information may comprise, without limitation, metering information, parking place utilization information and/or imaging information received from the respective parking enforcement platforms 104. In one embodiment, the controller 108 forwards at least a portion of the parking enforcement information to a database 110. The database 110 stores parking enforcement information, and optionally may store location information, time-of-day information, parking restrictions, parking fee information or the like correlated with the parking enforcement information. The database 112 may receive the information from the parking enforcement platforms 104, controller 108 or from external entities. As will be appreciated, the controller 108 and database 110 are functional elements that may reside individually or collectively in one or more physical structures or may be implemented in software. Optionally, the controller 108 and database 110 functionality may be distributed in whole or in part among one or more of the parking enforcement platforms 104.

In one embodiment, the data collection system 102 therefore detects parking enforcement information through operation of the parking enforcement platforms 104; the controller 108 coordinates operation and collects information from the parking enforcement platforms; and the database 110 maintains one or more records associated with the parking enforcement information. The parking enforcement platforms 104, controller 108 and database 110 are connected by logical links 106 comprising, without limitation, wireline or wireless links.

In one embodiment, the data collection system 102 communicates parking enforcement information obtained from the parking enforcement platforms to external devices or law enforcement personnel. To that end, the data collection system 102 is interconnected by a network 112 to an appropriate law enforcement end user terminal 114. This may be useful in the enforcement of local policy such as a paper ticket attached to the vehicle, booting the vehicle, or even towing the vehicle away The network 112 comprises generally any network operable to pass parking enforcement information from the data collection system 102 to the end user terminal 114 and vice versa. For example and without limitation, the network may comprise an IP Multimedia Subsystem (IMS) network, a wireless network (e.g., CDMA-based or GSM-based network), a circuit-switched network, a packet-based network (IP network) or another type of network. Alternatively or additionally, the data collection system may support direct connectivity and communication of parking enforcement information with certain end user terminals 114 without an interconnecting network 112.

The end user terminal (UE) 114 may comprise generally any device or combination of devices having capacity to request and receive information content from the data collection system 102 via network 112 (for example and without limitation, a mobile phone, wireline phone, a PDA, VoIP phone or SIP phone, laptop or desktop computer) or without requiring a network connection (for example and without limitation, a meter reading device for reading parking enforcement information directly from the parking enforcement platforms 104). As will be appreciated, the term “directly” as used herein is not limited to a direct physical or wired connection, but also includes wireless connection modalities.

The UE 114 may employ user interfaces including, without limitation, numeric or alpha-numeric keypads, keyboards, text displays, audio-visual displays and the like to request and receive parking enforcement information content from the data collection system 102. As shown, the UE 114 includes I/O devices 116, processor 118 and memory 120. It should be understood that these devices are functional elements that may be implemented to perform any of the various functions of the UE 114. The term “I/O devices” as used herein is intended to encompass one or more communication modalities (e.g., without limitation, voice, data, text, e-mail) for communicating information/data between the UE 114 and the data collection system 102 or the network 112. The term “processor” as used herein is intended to include one or more processing devices, including a central processing unit (CPU) or other processing circuitry, including but not limited to one or more signal processors, one or more integrated circuits, and the like. The term “memory” as used herein is intended to include memory associated with a processor or CPU, such as RAM, ROM, a fixed memory device (e.g., hard drive), or a removable memory device (e.g., diskette or CDROM).

Now referring to FIG. 2, the functional components of the parking enforcement platform 104 will be described in greater detail. A detector module 202 and imaging module 204 are operable to collect parking space utilization information and imaging information, respectively, associated with one or more designated parking spaces and vehicles therein. For example and without limitation, the detector module 202 may comprise one or more ultrasonic proximity detectors, photo detectors, strain gauges for detecting the weight of vehicles or objects occupying the parking spaces, magnetometers for detecting metallic components of vehicles or objects, and so forth; and the imaging module 204 may comprise, without limitation a camera for capturing still photographs or a video camera for capturing video segments/clips corresponding to utilization of the assigned parking space(s). Depending on the implementation and/or modality, the detector module 202 and/or imaging module 204 may be physically mounted in or on the parking enforcement platform 104 or may reside externally to the parking enforcement platform 104.

A metering device 206 includes a payment device, timer and display for collectively performing the so called “metering functions” of receiving payment, monitoring and displaying time allotted for lawful utilization of the parking space (i.e., time purchased or remaining) and displaying indicia of the time remaining or meter expiration.

A data interface 210 communicates or provides access to parking enforcement information (e.g., metering information, parking space utilization information and imaging information) from the parking enforcement platform to external devices or law enforcement personnel. In one embodiment, the data interface 210 communicates the parking enforcement information to the controller 108 and/or database 110; and in turn, the controller 108 and/or database may communicate the parking enforcement information to an end user terminal via network 112. The information may be communicated automatically or on-demand from the end user terminal. Alternatively or additionally, the data interface may provide a direct interface from the parking enforcement platform to a meter reading device, scanner or the like operated, for example, by meter maids or other “on site” parking enforcement personnel.

As shown, the parking enforcement platform 104 further comprises a processor 212, memory 214 and alarm module 216. The processor 212 may comprise one or more processing devices including, without limitation, a central processing unit (CPU) or other processing circuitry, including but not limited to one or more signal processors, one or more integrated circuits, and the like. The memory 214 is intended to include memory associated with a processor or CPU, such as RAM, ROM, a fixed memory device (e.g., hard drive), or a removable memory device (e.g., diskette or CDROM).

The alarm module 216 provides alerts to parking enforcement personnel responsive to certain events or prospective events, including, without limitation, meter expiration, obstruction of the imaging module, vandalism, payment improprieties, malfunction of the imaging module or other PEP components. As will be appreciated, virtually any type of alarm modality (e.g., lights, colors, tones, horns, etc.) may be employed; and the alerts may be provided locally at the parking enforcement platform, remotely to the controller 108 or UE 114, or both locally and remotely.

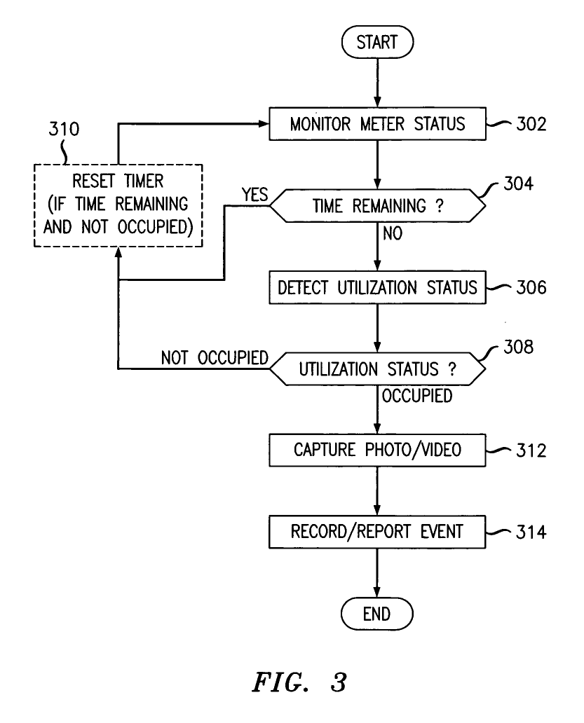

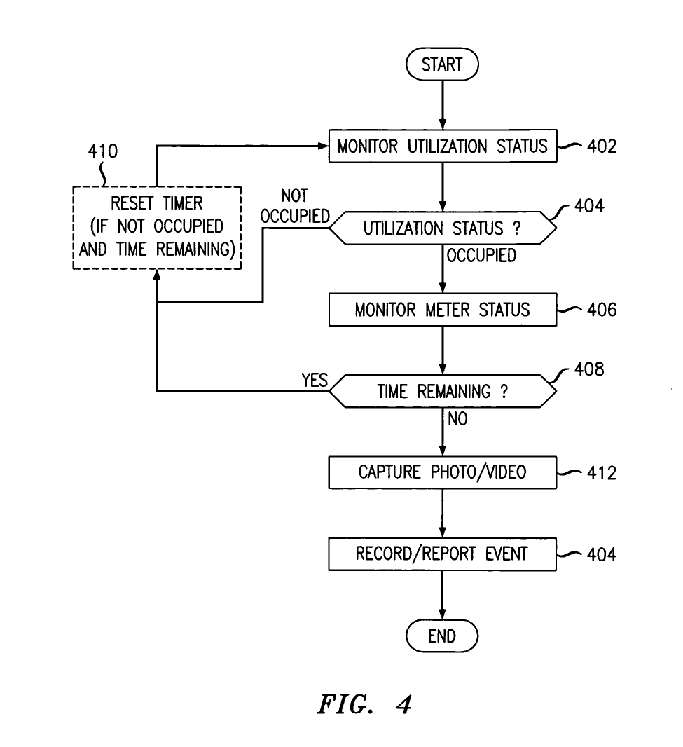

FIG. 3 and FIG. 4 are flowcharts associated with operation of the image-enhanced parking enforcement system of FIG. I according to an exemplary embodiments of the invention. FIG. 3 and FIG. 4 include steps that are implemented, where applicable, by the detector module 202, imaging module 204 and metering device 206 of the parking enforcement platform 104. Software instructions or code for performing the steps may be stored in the memory 214 and, when ready to be utilized, executed by the processor 212 of the parking enforcement platform 104. As will be appreciated, however, the steps of FIG. 3 and FIG. 4 may involve coordinated action or communication with the controller 108, database 110 and UE 114 of the image enhanced parking enforcement system.

Referring initially to FIG. 3, the metering device 206 coincident to performing its general metering functions will monitor the meter status at step 302 (i.e., the time purchased or remaining for lawful utilization of a designated parking space). At step 304, a determination is made whether the parking space has a paid (i.e., time remaining) status or an expired (i.e., no time remaining) status.

If there is time remaining, the process returns to step 302 and the metering device continues to monitor the meter status until such time as the meter has expired.

If the meter has expired, the process advances to step 306 whereby the detector module 202 detects the utilization status of the designated parking space (e.g., the presence or absence of vehicles (V) or other blocking structures in the designated parking space). At step 308, a determination is made whether the parking space utilization status is “occupied” or “not occupied.”

If the parking space is not occupied, presumably no parking infraction has occurred and the process returns to step 302 to resume monitoring the meter status.

Optionally, a determination of utilization status may be made following block 304 when the meter is not expired. In such case, if the meter is not expired and the parking space is not occupied, the meter time may be reset to zero at step 310 to prevent subsequent vehicles from “piggybacking” off the time purchased by a previous vehicle.

Following block 308, if the parking space is occupied, presumably a parking infraction has occurred and the vehicle parked in the space with the expired meter is subject to parking tickets, fines or the like.

At step 312, responsive to occupation of the parking space and meter expiration, the imaging module captures one or more images corresponding to the designated parking space and/or vehicle. For example and without limitation, the imaging module may capture photo images or video clips of the license plate or other identifying features of the vehicle.

Thereafter, at step 314, the data collection system 102 records and/or reports the event. For example and without limitation, parking enforcement information comprising imaging information, metering information and/or parking space utilization information associated with the event may be stored in the database 110 of the data collection system 102 or in the memory 214 of the parking enforcement platform. Thereafter, the parking enforcement information may be retrieved on-demand or communicated automatically to parking enforcement personnel.

Now referring to FIG. 4, there is shown an alternative method of operation of the image-enhanced parking enforcement system of FIG. 1.

At step 402, the detector module 202 detects the utilization status of the designated parking space (i.e., irrespective of meter status). At step 404, a determination is made whether the parking space utilization status is “occupied” or “not occupied.”

If the parking space is not occupied, the process returns to step 402 and the detector module continues to monitor the utilization status until such time as the parking space is occupied.

If the parking space is occupied, the metering device 206 will monitor the meter status at step 406. At step 408, a determination is made whether the parking space has a paid (i.e., time remaining) status or an expired (i.e., no time remaining) status.

If there is time remaining, presumably no parking infraction has occurred and the process returns to step 402 to resume monitoring the utilization status.

Optionally, a determination of time remaining status may be made following block 404 when the parking space is not occupied. In such case, if the meter is not expired and the parking space is not occupied, the meter time may be reset to zero at step 410 to prevent subsequent vehicles from “piggybacking” off the time purchased by a previous vehicle.

Following block 408, if the meter is expired, presumably a parking infraction has occurred and the vehicle parked in the space with the expired meter is subject to parking tickets, fines or the like.

At step 412, responsive to occupation of the parking space and meter expiration, the imaging module captures one or more images corresponding to the designated parking space and/or vehicle. For example and without limitation, the imaging module may capture photo images or video clips of the license plate or other identifying features of the vehicle.

Thereafter, at step 414, the data collection system 102 records and/or reports the event. For example and without limitation, parking enforcement information comprising imaging information, metering information and/or parking space utilization information associated with the event may be stored in the database 110 of the data collection system 102 or in the memory 214 of the parking enforcement platform. Thereafter, the parking enforcement information may be retrieved on-demand or communicated automatically to parking enforcement personnel.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. For example, embodiment herein are not limited to enforcement of automobile parking spaces but may be applied generally to police any controlled physical or virtual space that is subject to metering, and hence subject to unauthorized use or occupation of the controlled space. The scope of the invention is, therefore, indicated by the appended claims rather than by the foregoing description. All changes that come within the meaning and range of equivalency of the claims are to be embraced within their scope.

What is claimed is:

1. A parking enforcement platform comprising:
a metering device corresponding to a controlled parking space, the metering device operable to monitor allotted times for lawful utilization of the parking space and identify instances of expiration of the allotted times, defining meter expiration;
at least one detector for monitoring utilization status of the parking space; and
an imaging device operable to capture one or more images corresponding to the parking space responsive to occupation of the parking space and meter expiration.

2. The platform of claim 1, further comprising means for communicating parking enforcement information including at least a portion of the one or more images to a parking enforcement authority.

3. The platform of claim 1, further comprising means for storing at least a portion of the one or more images.

4. The platform of claim 1, wherein the imaging device comprises a camera for capturing still photographs corresponding to utilization of the parking space.

5. The platform of claim 1, wherein the imaging device comprises a video camera for capturing video clips corresponding to utilization of the parking space.

6. The platform of claim 1, further comprising a security module for detecting incidents of obstruction of the imaging device; and an alarm for reporting the incidents to a parking enforcement authority.

7. The platform of claim 1, wherein the at least one detector comprises one or more of an ultrasonic proximity detector, strain gauge, photo detector and magnetometer.

8. The platform of claim 1, wherein the one or more images comprises one or more of a vehicle image and a license plate image.

9. A method comprising:
monitoring status of a metering device corresponding to a controlled parking space, the metering device operable to monitor allotted times for lawful utilization of the parking space and identify instances of expiration of the allotted times, defining meter expiration;
monitoring utilization status of the parking space; and
capturing one or more images corresponding to the parking space responsive to occupation of the parking space and meter expiration.

10. The method of claim 9, further comprising communicating parking enforcement information including at least a portion of the one or more images to a parking enforcement authority.

11. The method of claim 9, further comprising storing at least a portion of the one or more images.

12. The method of claim 9, wherein the step of capturing images comprises capturing still photographs corresponding to utilization of the parking space.

13. The method of claim 9, wherein the step of capturing images comprises capturing video clips corresponding to utilization of the parking space.

14. The method of claim 9, wherein the step of capturing images comprises capturing one or more of a vehicle image and a license plate image.

15. The method of claim 9, further comprising:
detecting incidents of obstruction of the imaging device; and
reporting the incidents to a parking enforcement authority.

16. The method of claim 9, wherein the step of monitoring utilization status of the parking space is accomplished responsive to detecting meter expiration.

17. The method of claim 9, wherein the step of monitoring status of the metering device is accomplished responsive to detecting occupation of the parking space.

18. The method of claim 9, further comprising resetting the allotted time to zero, if the parking space is unoccupied and the meter is not expired.
